(19) United States
(12) Patent Application Publication
(10) Pub. No.: US 2010/0031170 A1
(43) Pub. Date: Feb. 4, 2010

(54) Method and System for Managing Metadata Variables in a Content Management System

(76) Inventors: Vittorio Carullo, Roma (IT); Guarda Roberto, Pomezia (IT)

Correspondence Address: IBM CORPORATION;INTELLECTUAL PROPERTY LAW, 11501 BURNET ROAD, AUSTIN, TX, 78758, US

(21) Appl. No.: 12/181,512

(22) Filed: Jul. 29, 2008

(51) Int. Cl. G06F 3/048

(52) U.S. Cl. 715/762

(57) ABSTRACT

The method and system of the preferred embodiment employs a consolidated drag and drop paradigm to provide a mechanism for handling metadata in a content management software application. This improves upon traditional prior art text-based GUIs to enable users to access metadata. In particular, the traditional text-based GUIs tend to be awkward, unwieldy and unintuitive. In contrast, the method and system of the preferred embodiment provides a simple, speedy, convenient and intuitive mechanism for handling metadata. More particularly, the preferred embodiment provides a mechanism for:
adding a tag to a plurality of media objects;
copying a metadata subset from one media object to a one or more other media objects; and
modifying a wrong meta-datum in a set of media objects.

### TECHNICAL FIELD

The present invention relates to a method, system and computer program product for assigning a value of a metadata variable to an object in a content management system.

### BACKGROUND

Recent years have seen rapid growth in the area of content management, ranging from personal-use photo assistants (e.g. Google Picasa (trademark) and Adobe Photoshop Album (trademark)) to enterprise-sized Digital Asset Management Systems (DAMS). A content management system can be generically described as a software application for the handling of a media object (e.g. images, text, graphics, video etc.). Within a content management system, each individual media object is associated with pieces of information known as metadata. The metadata are typically organised as sets of type/value pairs; wherein some metadata types admit a single value (e.g. object creation date) and other metadata types admit multiple values (e.g. object attributes).

A tag is a single instance of a multiple-valued metadata type, which is essential for searching and classifying objects in a content management system. At present, most content management systems provide a metadata-related GUI to enable users to access metadata. However, these GUIs typically comprise an old-fashioned user interface (based on text input fields) which embrace all of the functionalities required for metadata handling.

### SUMMARY OF THE INVENTION

According to the invention there is provided a method of assigning a value of a metadata variable to a first object in a content management system, the method comprising the steps of:
identifying another object in the content management system possessing a required value of the corresponding metadata variable;
selecting an indicator of the metadata variable in the other object;
moving the indicator towards a representation of the first object; and
depositing the indicator at the representation of the first object, to cause the metadata variable of the first object to attain the value of the metadata variable in the other object.

The present invention enables speedy metadata update. The present invention also provides the possibility of managing pre-configured “metadata change” scenarios, without the necessity of knowing the details of the software application in question. Further aspects of the invention are provided in the appended claims.

### BRIEF DESCRIPTION OF THE DRAWINGS

An embodiment of the invention will herein be described by way of example only with reference to the accompanying Figures, in which:

FIG. 1 is a block diagram of a conventional NICA browser;

FIG. 2 is a block diagram of a detailed metadata view of the NICA browser shown in FIG. 1;

FIG. 3 is a block diagram of the NICA browser employing the method and system of the preferred embodiment; and

FIG. 4 is a block diagram of a computer on which the preferred embodiment operates.

### DETAILED DESCRIPTION OF THE INVENTION

The preferred embodiment employs a consolidated drag and drop paradigm to provide a simple, speedy and convenient mechanism for handling metadata, as-compared with the unwieldy text-based GUIs of the prior art. More particularly, the preferred embodiment provides a mechanism for:
adding a tag to a plurality of media objects;
copying a metadata subset from one media object to a one or more other media objects; and
modifying a wrong meta-datum in a set of media objects.

For simplicity, the preferred embodiment will be described with reference to an IBM NICA (Networked Interactive Content Access) Photo Archive interface. However, it will be understood that the preferred embodiment is not limited to this specific interface. Instead, the preferred embodiment is applicable to other content management interfaces.

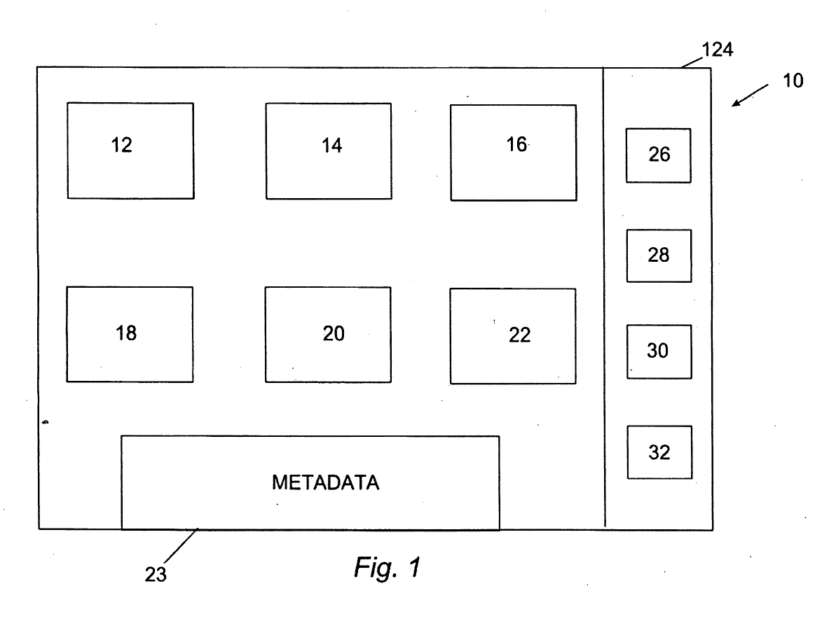

A NICA is an end-to-end digital asset management solution that provides the ability to manage, archive, retrieve, reuse and sell publishing content such as text, images, graphics. When using NICA (or any other software for digital content management) a user typically establishes a view comprising some objects, each one with its own metadata. For example, referring to FIG. 1, NICA Photo Archive users normally deal with large sets of images that they may browse quickly using NICA browser. The NICA browser view 10 presents image thumbnails 12, 14, 16, 18, 20, 22 and the most relevant metadata for the current object in a Quick Data Viewer (QDV) 23. A workpad 24 contains a group of objects previously selected.

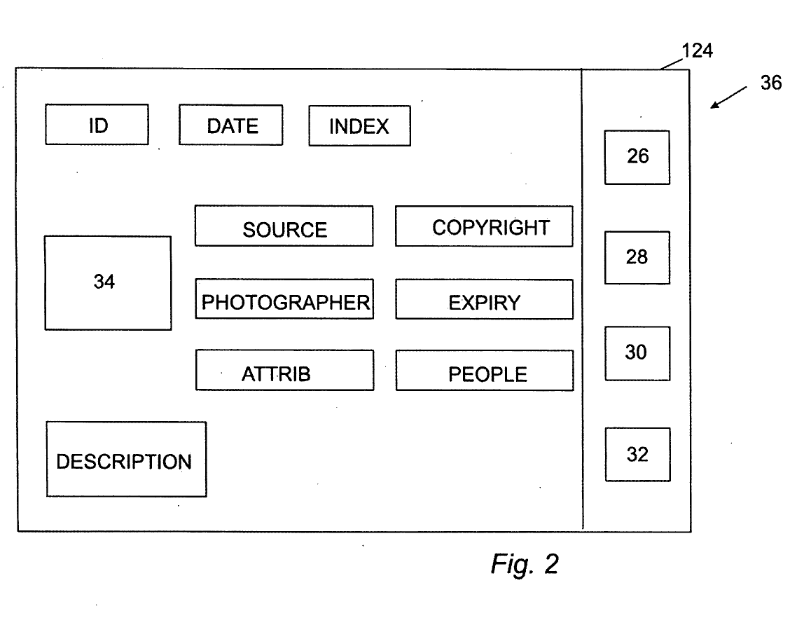

Referring to FIG. 2, if a user wants to access the entire set of metadata for an object 34 (or a group thereof), they can open a detailed metadata view 36. The detailed metadata view 36 provides tools for editing values of metadata, and copy/paste functionalities for copying and moving values among objects.

Copying and moving metadata values is useful in many situations. For example, if a group of incoming objects should share a common value or tag, a user can update the first object and then paste the value into others. Similarly, if a group of images were introduced into a content management system with some wrong metadata, the quickest way of fixing the error, is to select a similar object with correct metadata and copy the metadata values therefrom to the incorrect objects.

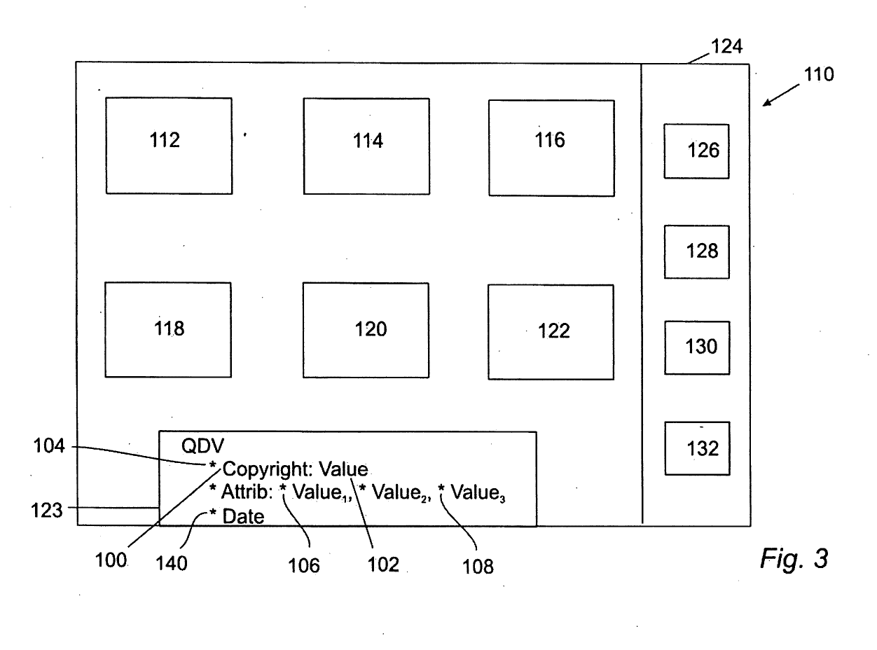

Central to the preferred embodiment is the concept that one or more metadata can be copied to an object or group of objects, by moving (i.e. dragging) metadata from a source object and depositing (i.e. dropping) it to a one or more target objects. A source window for determining which metadata to copy, may be the source object itself (in which case, all its metadata is copied) or the QDV (shown in FIG. 3) (for selecting a subset of the available metadata to copy).

In support of this concept, the preferred embodiment defines object metadata types as being “draggable” if the corresponding metadata value can be exchanged between objects using a drag and drop facility. The set of draggable metadata is user-configurable, meaning that system administrator can decide which metadata types are draggable and which ones are not. Furthermore, if a draggable metadata type admits multiple values (tags), each tag can be dragged separately.

A draggable metadata type is depicted in the QDV by a graphic symbol located proximal to the metadata type name. If the metadata type admits multiple values, the symbol is slightly modified. The graphic symbol is a drag source for the entire value of the metadatum, i.e. it can be selected and dragged to represent an operation involving that metadata value. A draggable tag is depicted in the QDV by a similar graphic symbol located proximal to the tag. The symbol is the drag source for the tag, i.e. it can be selected and dragged representing an operation involving that metadata tag.

The preferred embodiment enables a user to select more than one graphic symbol. More particularly, values and tags can be selected together. In this case, the corresponding drag will represent an operation involving all values and tags selected. The preferred embodiment also provides a shortcut, wherein the object title representation in a view is the drag source for the entire set of its draggable metadata. Furthermore, any object in a view may be a drop target for draggable metadata.

The drop operation of a draggable metadata value sets the metadata in the target object to the same value as it is in the source object. It is also possible to condition the result of a drop operation (e.g. replace current value, add to current value, etc.). A common method for conditioning the result of drop operation can be the use of a one or more “modifiers” keys during the above drag and drop operation. For instance, keeping a “Ctrl” key pressed during the drag and drop operation typically forces the preferred embodiment to add values rather than replacing them. Taking the NICA Photo Archive as an example, let the metadata types defined to be draggable comprise:
copyright (single value metadata type);
attributes (multiple value metadata type, like sunset, landscape etc.); and
date created (single value metadata type)
   In the QDV, these data are shown with the associated graphic symbols which indicate the metadata values and the tags that may be dragged.

A graphic symbol associated with a draggable metadata or tag, may be selected by a user, by clicking on it with a mouse. Multiple selections are also possible. Following its selection, a graphic symbol may be dragged (using a mouse) and dropped on a target, to add the selected metadata thereto. As discussed, the result of a drop operation can also be modified by the user. For example:
the target object's metadata values may be set to those of the source object, if the target object's metadata field is empty;
new tag values may be added to those of the target object; and
new metadata values (from the source object) may overwrite the old values of the target object.

The above discussions may be clarified by referring to some specific examples shown in FIG. 3.

### Case 1: Setting a Metadata Value of an Object

Let an object 120 be missing a copyright tag value. However, let an object 116 possess a copyright tag 100 with value 102. It is desired to set the copyright tag of object 120 to the value of the copyright tag of object 116. In this case, the preferred embodiment allows a user to click on object 116 (so that its metadata are shown in a QDV 123) and click on the graphic symbol 104 proximal to the copyright tag 100 in the QDV 123, so that the value 102 of the copyright tag 100 is selected. The user may then drag the graphic symbol 104 towards object 120; and drop the graphic symbol 104 on a thumbnail for object 120. In this case, the copyright tag of object 120 is set to the same value as that of object 116.

### Case 2: Setting a Metadata Value for a List of Objects

Let objects 126, 128 be missing a copyright tag value. It is desired to set the copyright tags of objects 126 and 128 to the value of the copyright tag of object 116. In this case, the preferred embodiment allows a user to click on object 116 (so that its metadata are shown in the QDV 123) and click on the graphic symbol 104 proximal to the copyright tag 100 in the QDV 123, so that the value 102 of the copyright tag 100 is selected. The user may then drag the graphic symbol. 104 towards the objects 126 and 128 in the NICA workpad 124. The user can then drop the graphic symbol 104 on the workpad 124 and the copyright tag value of all the objects in the workpad 124 are set to the value of the copyright tag of source object 116.

### Case 3: Adding Metadata Values to a List of Objects

In this case, a user wishes to add some of the tags listed among the attributes of a source object to a one or more target objects. For example, let the user wish to add Value₁ and Value₃ of the attribute (listed in the QDV 123) of object 116, to the target object 130. The preferred embodiment allows a user to click on object 116 (with the required attribute values) and select the objects (e.g. object 130) to be updated in the NICA workpad 124. The user is then allowed to click on the graphic symbols 106 and 108 in the QDV 123 corresponding to the tags of the attribute field (i.e. Value₁ and Value₁) to be added to those of the target object 130.

The user is then allowed to drag the selected tags towards the object present in the workpad 124, press the Ctrl key on the computer keyboard and drop the tags on the workpad 124 keeping Ctrl key pressed. This causes the dropped tags to be added to the current attributes listed for all the objects in the workpad 124.

### Case 4: Replacing Metadata Values in Objects

For example, let a user wish to change a creation date of object 118, so that it is set to the creation date of object 130. The preferred embodiment allows the user to click on object 130 (with correct creation date); and click on the graphic symbol 140 located proximal to the date field in the QDV 123. The user is then allowed to drag the graphic symbol 140 towards the thumbnail of object 118 and drop the tag on the thumbnail. This causes the current creation date of object 118 to be overwritten with the selected creation date of object 130.

Case 5: Copying all Metadata from One Object to Another

In this case, a user wants objects 114 and 116 to have the same metadata values (with reference to a draggable metadata set). The preferred embodiment allows a user to click on source object 114 (with the required metadata shown in the QDV 123) and drag a title of the object 114 (typically shown below the object 114) towards object 116 (to be updated).

The user is then allowed to drop the title on a thumbnail of the object 116. This causes the values of all the draggable metadata in object 114 to be copied to object 116.

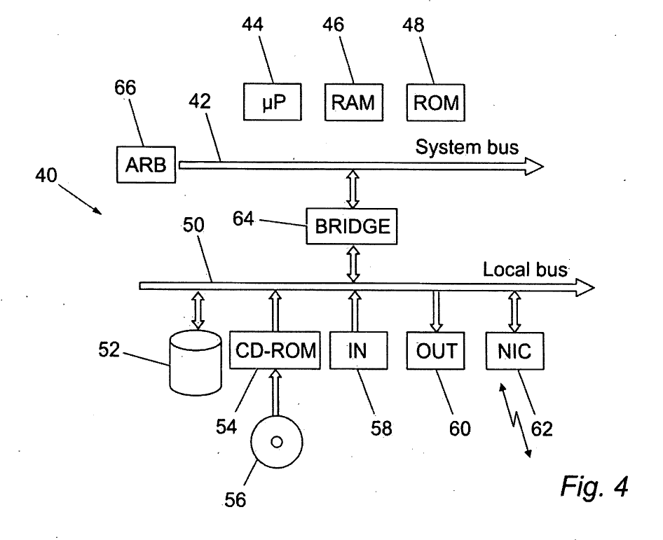

A machine on which the preferred embodiment operates has a generic structure shown in FIG. 4. More particularly, a generic computer of the system is denoted with 40. The computer 40 is formed by several units that are connected in parallel to a system bus 42. In detail, one or more microprocessors 44 control operation of the computer 40; a RAM 46 is directly used as a working memory by the microprocessors 44, and a ROM 48 stores basic code for a bootstrap of the computer 40. Peripheral units are clustered around a local bus 50 (by means of respective interfaces). Particularly, a mass memory consists of a hard-disk 52 and a drive 54 for reading CD-ROMs 56. Moreover, the computer 40 includes input devices 58 (for example, a keyboard and a mouse), and output devices 60 (for example, a monitor and a printer). A Network Interface Card (NIC) 62 is used to connect the computer 40 to the network. A bridge unit 64 interfaces the system bus 42 with the local bus 50. Each microprocessor 44 and the bridge unit 64 can operate as master agents requesting an access to the system bus 42 for transmitting information. An arbiter 66 manages the granting of the access with mutual exclusion to the system bus 42.

Modifications and alterations may be made to the above without departing from the scope of the invention.

1. A method of assigning a value of a metadata variable to a first object in a content management system, the method comprising the steps of:
identifying another object in the content management system possessing a required value of a corresponding metadata variable;
selecting an indicator of the metadata variable in the other object;
moving the indicator towards a representation of the first object; and
depositing the indicator at the representation of the first object to cause the metadata variable of the first object to attain the value of the corresponding metadata variable in the other object.

2. The method of claim 1, wherein the step of depositing the indicator at the representation of the first object causes the value of the corresponding metadata variable of the other object to be added to the one or more values of the metadata variables already possessed by the first object.

3. The Method of claim 1 of assigning a value of a metadata variable to a plurality of first objects in a content management system,
wherein the steps of moving and depositing the indicator further comprise the steps of:
moving the indicator towards a representation of the plurality of first objects; and
depositing the indicator at the representation to cause the metadata variable of the first objects to attain the value of the corresponding metadata variable in the other object

4. A System for assigning a value of a metadata variable to a first object in a content management system, the system comprising processor and memory and a computer instructions adapted to carry out the steps of the method comprising the steps of:
identifying another object in the content management system possessing a required value of a corresponding metadata variable;
selecting an indicator of the metadata variable in the other object;
moving the indicator towards a representation of the first object; and
depositing the indicator at the representation of the first object to cause the metadata variable of the first object to attain the value of the corresponding metadata variable in the other object.

5. A Computer program product stored on a medium readable by a computer machine, for providing a value of a metadata variable to a first object in a content management system, the computer program product tangibly embodying readable program means for causing the computer machine to carry out steps of the method comprising the steps of:
identifying another object in the content management system possessing a required value of a corresponding metadata variable;
selecting an indicator of the metadata variable in the other object;
moving the indicator towards a representation of the first object; and
depositing the indicator at the representation of the first object to cause the metadata variable of the first object to attain the value of the corresponding metadata variable in the other object.
